(19) United States
(12) Patent Application Publication
(10) Pub. No.: US 2023/0295013 A1
(43) Pub. Date: Sep. 21, 2023

(54) ULTRAVIOLET IRRADIATION DEVICE

(71) Applicant: Enplas Corporation, Saitama (JP)

(72) Inventors: Toshinori OKADA, Saitama (JP); Kakeru NAKAMURA, Saitama (JP)

(21) Appl. No.: 18/183,443

(22) Filed: Mar. 14, 2023

(30) Foreign Application Priority Data
Mar. 16, 2022 (JP) 2022-041662

(51) Int. Cl. C02F 1/32

(52) U.S. Cl. CPC C02F 1/32; C02F 2201/004; C02F 2201/3222

(57) ABSTRACT

An ultraviolet irradiation device includes a storage wall defining a space configured to store fluid, and a light source configured to simultaneously emit ultraviolet light and visible light into the space. The storage wall includes a first transmission portion which is formed thinner than other regions of the storage wall and is configured to transmit part of the visible light emitted from the light source to the space.

### CROSS REFERENCE TO RELATED APPLICATIONS

This application is entitled to the benefit of Japanese Patent Application No. 2022-041662, filed on Mar. 16, 2022, the disclosure of which including the specification, drawings and abstract is incorporated herein by reference in its entirety.

### TECHNICAL FIELD

The present invention relates to an ultraviolet irradiation device for irradiating a fluid with ultraviolet light.

### BACKGROUND ART

It is widely known that ultraviolet light can be used to sterilize fluids, such as liquids. For example, Patent Literature (hereinafter, referred to as PTL) 1 describes a fluid sterilization device that sterilizes a fluid flowing through a channel extending in the axial direction by irradiating the fluid with ultraviolet light in the axial direction.

Specifically, the fluid sterilization device described in PTL 1 includes a light source including a semiconductor light emitting element that emits ultraviolet light, and a housing having a channel through which the fluid to be sterilized flows in the axial direction of the channel. The light source is disposed at one end of the housing in the axial direction. The housing is made of stainless steel and has a tapered structure such that the cross-sectional area of the channel gradually increases from the one end toward the other end. The tapered structure has an inclination that matches the orientation angle of the semiconductor light emitting element. In addition, an adjusting means for adjusting the flow of the fluid is provided at the other end of the housing.

PTL 1 teaches that the tapered structure (having an inclination that matches the orientation angle of the semiconductor light emitting element) of the housing allows ultraviolet light to reach far away from the light source. PTL 1 also teaches that by irradiating the fluid whose flow is adjusted by the adjusting means, the fluid is evenly irradiated with the ultraviolet light, thereby increasing the sterilization effect.

### CITATION LIST

### Patent Literature

PTL 1 Japanese Patent Application Laid-Open No. 2019-98055

### SUMMARY OF INVENTION

### Technical Problem

The housing of the fluid sterilization device described in PTL 1 is made of stainless steel; therefore, the confirmation of whether the semiconductor light emitting element is lit or not is not possible from the outside, thereby making impossible to determine whether the fluid is properly sterilized is not.

An object of the present invention is to provide an ultraviolet irradiation device that allows the lighting state of a light source to be visually recognized from the outside of the device.

### Solution to Problem

An ultraviolet irradiation device according to one embodiment of the present invention is an ultraviolet irradiation device configured to irradiate a fluid with ultraviolet light. The ultraviolet irradiation device includes: a storage wall defining a space configured to store the fluid; and a light source configured to simultaneously emit ultraviolet light and visible light into the space. The storage wall includes a first transmission portion formed thinner than a region of the storage wall other than the first transmission portion and configured to transmit part of the visible light emitted from the light source to the space.

### Advantageous Effects of Invention

The present invention is capable of providing an ultraviolet irradiation device that allows the lighting state of a light source to be visually recognized from the outside of the device.

### BRIEF DESCRIPTION OF DRAWINGS

FIG. 1 is a cross-sectional perspective view of an ultraviolet irradiation device according to Embodiment 1;

FIGS. 2A and 2B are graphs each showing the relationship between the wavelength of light and the transmittance or reflectance of the light in first transmission portions having different thicknesses.

FIG. 3 is a graph showing the relationship between the wavelength of light and the transmittance of the light for PP, PC, and PMMA;

FIG. 4 is a cross-sectional perspective view of an ultraviolet irradiation device according to Embodiment 2; and

FIGS. 5A to 5C illustrate the configuration of an ultraviolet irradiation device according to Embodiment 3.

### DESCRIPTION OF EMBODIMENTS

Hereinafter, an ultraviolet irradiation device according to an embodiment of the present invention will be described in detail with reference to the attached drawings. In the following description, an example in which the ultraviolet irradiation device is applied to a sterilization device for sterilizing fluid will be described.

### Embodiment 1

### Configuration of Ultraviolet Irradiation Device

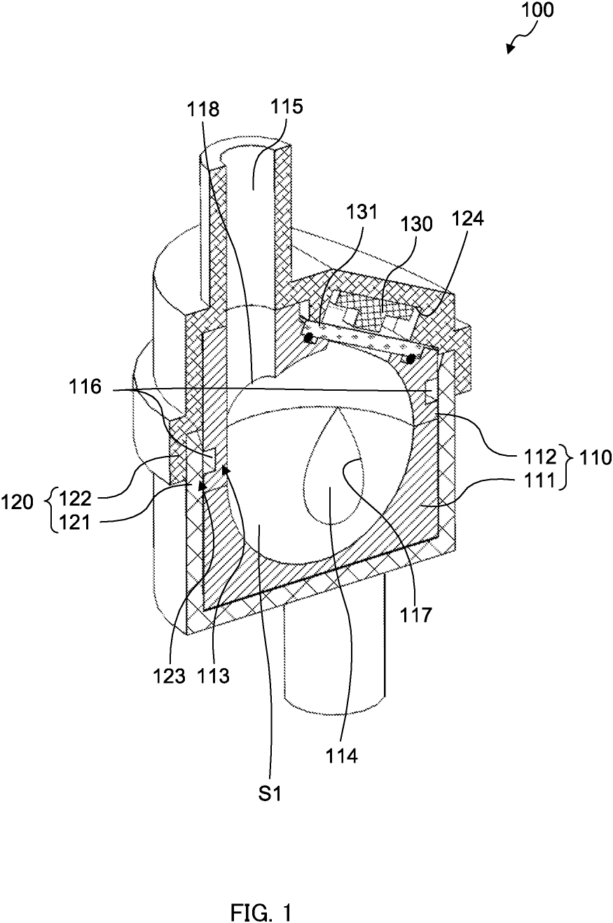

FIG. 1 is a cross-sectional perspective view of ultraviolet irradiation device 100 according to Embodiment 1.

As illustrated in FIG. 1, ultraviolet irradiation device 100 is a device for irradiating fluid with ultraviolet light. Ultraviolet irradiation device 100 includes storage wall 110 defining space S1 configured to store a fluid, and light source 130 configured to emit ultraviolet light and visible light into space S1. In the present embodiment, ultraviolet irradiation device 100 further include cover 120 that covers storage wall 110.

Storage wall 110 defines space S1 configured to house a fluid. As will be described below, in ultraviolet irradiation device 100 according to the present embodiment, storage wall 110 includes first transmission portion 113. Of the light emitted from light source 130, storage wall 110 mainly reflects the ultraviolet light toward space S1 and transmits part of the visible light to the outside through first transmission portion 113. Storage wall 110 may have any configuration as long as the storage wall can exhibit the above functions. Storage wall 110 may be composed of one member or two or more members. In the present embodiment, storage wall 110 includes two members, namely first wall 111 and second wall 112. Examples of the shape of space S1 defined by storage wall 110 (first wall 111 and second wall 112) include spherical shapes, cylindrical shapes, and prismatic shapes. In the present embodiment, the shape of space S1 defined by storage wall 110 (first wall 111 and second wall 112) is substantially spherical. First wall 111 defines one of the substantially hemispherical shapes of space S1, and second wall 112 defines the other one of the substantially hemispherical shapes of space S1. In the present embodiment, first wall 111 also defines part of supply channel 114 (described below) and second wall 112 also defines part of discharge channel 115 (described below). In the present embodiment, first wall 111 is disposed on the upstream side in the flow direction of the fluid, and second wall 112 is disposed on the downstream side in the flow direction of the fluid. Space S1 having the substantially spherical shape is formed by joining first wall 111 and second wall 112 together.

Any material may be used for storage wall 110 as long as the material is resistant to deterioration by ultraviolet light and can exhibit the above functions. The materials of first wall 111 and second wall 112 may be the same or different from each other. In the present embodiment, materials of first wall 111 and second wall 112 are identical to each other. An example of the material for first wall 111 and second wall 112 is polytetrafluoroethylene (PTFE). The materials of first wall 111 and second wall 112 are preferably PTFE from the viewpoint of efficiently reflecting ultraviolet light. In the present embodiment, both the first wall 111 and second wall 112 are made of PTFE. The inner diameter of storage wall 110 is not limited, but is, for example, approximately 20 to 60 mm. Setting the inner diameter of storage wall 110 to approximately 20 to 60 mm can satisfactorily sterilize the fluid inside storage wall 110 even when only one UV-C LED is used as light source 130.

In the present embodiment, first transmission portion 113 is disposed in second wall 112, and second wall 112 and first transmission portion 113 are integrally molded. In addition, supply channel 114 and discharge channel 115 are connected to space S1.

First transmission portion 113 is a region formed thinner than other regions of storage wall 110. That is, first transmission portion 113 is part of storage wall 110. First transmission portion 113 transmits part of the visible light, emitted from light source 130 to space S1, to the outside. More specifically, first transmission portion 113 reflects the ultraviolet light emitted from light source 130 and transmits part of the visible light emitted from light source 130. The position of first transmission portion 113 is not limited. At least part of first transmission portion 113 is preferably disposed closer to light source 130 than a virtual plane is, in storage wall 110. Here, the virtual plane is a plane passing through the center of gravity of space S1 and perpendicular to the optical axes of the ultraviolet light and the visible light emitted from light source 130. In other words, first transmission portion 113 is preferably disposed at a position where low-intensity ultraviolet light in the ultraviolet light emitted from light source 130 reach. In the present embodiment, first transmission portion 113 is disposed in second wall 112 in the vicinity of the boundary between second wall 112 and first wall 111 so as to surround the substantially hemispherical part of space S1 defined by second wall 112. As a result, of the ultraviolet light emitted from light source 130, high-intensity ultraviolet light directly reaches the regions other than first transmission portion 113. Therefore, the reduction in the sterilization effect which would be caused by first transmission portion 113 can be prevented. In addition, first transmission portion 113 is disposed in a thin portion of second wall 112; thus the amount of cutting work can be reduced, and the manufacturing cost can also be reduced.

First transmission portion 113 may have any configuration as long as the first transmission portion can exhibit the above functions. In the present embodiment, first transmission portion 113 is a region between the inner surface of first recess 116 disposed in the outer surface of storage wall 110 (second wall 112) and the inner surface of storage wall 110 (second wall 112). The number of first recesses 116 is not limited. The number of first recesses 116 may be one, or two or more. In the present embodiment, the number of first recesses 116 is one. First recess 116 may have any shape as long as part of second wall 112 is formed thin. Examples of first recess 116 include grooves and depressions. In the present embodiment, first recesses 116 is a groove.

The groove may have any shape. An example of the shape of the groove is a groove formed from two inner surfaces and one bottom surface. In the present embodiment, the groove includes two inner surfaces and one bottom surface. In other words, first transmission portion 113 is a region between the bottom surface of the groove and the inner surface of second wall 112 in the present embodiment. The relationship between the thickness of first transmission portion 113 and the reflectance of ultraviolet light and visible light or the transmittance of ultraviolet light and visible light will be described below.

Supply channel 114 supplies a fluid to the inside (space S1) of storage wall 110. One end of supply channel 114 opens into space S1. The opening of supply channel 114 to space S1 is supply port 117. Supply channel 114 is preferably disposed so as to smoothly supply a fluid into the inside of storage wall 110 (space S1) along the inner surface of storage wall 110. In the present embodiment, at a connection portion, part of the inner surface of supply channel 114 is disposed smoothly continuous with the inner surface of storage wall 110 so as to match the tangent line of the inner surface of storage wall 110 at the connection portion. Here, the connection portion is a connection portion between the inner surface of supply channel 114 and the inner surface of storage wall 110 in the cross section that is along the flow direction of fluid in supply channel 114 and includes the center of gravity of space S1. In the present embodiment, supply channel 114 is formed from part of storage wall 110 (first wall 111) and part of cover 120 (first cover 121).

Discharge channel 115 discharges the fluid inside storage wall 110 (space S1). One end of discharge channel 115 opens into space S1. The opening of discharge channel 115 to space S1 is discharge port 118. Discharge channel 115 is preferably disposed so as to smoothly discharge the fluid from the inside of storage wall 110 (space S1) along the wall of storage wall 110. In the present embodiment, at a connection portion, part of the inner surface of discharge channel 115 is disposed smoothly continuous with the inner surface of storage wall 110 so as to match the tangent line of the inner surface of storage wall 110 at the connection portion. Here, the connection portion is a connection portion between the inner surface of discharge channel 115 and the inner surface of storage wall 110 in the cross section that is along the flow direction of fluid in discharge channel 115 and includes the center of gravity of storage wall 110. In the present embodiment, discharge channel 115 is formed from part of storage wall 110 (second wall 112) and part of cover 120 (second cover 122).

Cover 120 covers and holds storage wall 110. Cover 120 includes second transmission portion 123 configured to transmit or diffuse visible light that has passed through (transmitted by) first transmission portion 113. Cover 120 may have any configuration as long as the cover can exhibit the above functions. Cover 120 may be composed of one member or two or more members. In the present embodiment, cover 120 is formed from two members, namely first cover 121 and second cover 122. The materials of first cover 121 and second cover 122 may be the same or different from each other. In the present embodiment, the materials of first cover 121 and second cover 122 are different from each other. In the present embodiment, visible light is transmitted by first cover 121. Examples of materials for first cover 121 include polypropylene (PP), polycarbonate (PC), and polymethylmethacrylate (PMMA). In the present embodiment, the material of first cover 121 is translucent PP. As first cover 121 is made of PP as described above, visible light that has passed thorough first transmission portion 113 can be diffused. In addition, the inner surface or outer surface of first cover 121 is preferably coated with polycarbonate (PC), polymethyl methacrylate (PMMA), or the like so that ultraviolet light is not transmitted. Although details will be described below, PC and PMMA mainly do not transmit ultraviolet light, but mainly transmit visible light. Thus, first cover 121 uses PP to diffuse and/or transmit visible light, and PC or PMMA to reflect ultraviolet light. Examples of the materials for second cover 122 include various metals, polypropylene (PP), acrylonitrile-butadiene rubber-styrene copolymer (ABS resin), polystyrene, and acrylonitrile-styrene copolymer (AS resin). In the present embodiment, material of second cover 122 is aluminum from the viewpoint of allowing the second cover to function as a heat sink for light source 130.

First cover 121 includes second transmission portion 123 and covers first wall 111. In the present embodiment, first cover 121 covers the entire first wall 111 and part of second wall 112. More specifically, first cover 121 covers the entire first wall 111 and the portion of second wall 112 where first transmission portion 113 is disposed in the present embodiment. In addition, in the present embodiment, first cover 121 defines part of supply channel 114. Specifically, first cover 121 defines the upstream side of supply channel 114.

Second transmission portion 123 transmits or diffuses visible light that has passed through first transmission portion 113. Second transmission portion 123 may have any configuration as long as the second transmission portion can exhibit the above functions. In the present embodiment, second transmission portion 123 is a portion of first cover 121, the portion facing first transmission portion 113. In other words, in the present embodiment, second transmission portion 123 is a region that is part of first cover 121 and disposed so as to surround first transmission portion 113. Therefore, it is preferable that first cover 121 and second transmission portion 123 are made of the same material. In the present embodiment, the thickness of second transmission portion 123 is the same as those of other portions of first cover 121.

Second cover 122 covers second wall 112. In the present embodiment, second cover 122 covers part of second wall 112 and part of first cover 121. In addition, in the present embodiment, second cover 122 defines part of discharge channel 115. Specifically, second cover 122 defines the downstream side of discharge channel 115. Second recess 124 in which light source 130 is disposed is disposed in second cover 122.

Light source 130 irradiates a fluid inside storage wall 110 (space S1) with ultraviolet light. In the present embodiment, light source 130 simultaneously emits ultraviolet light and visible light into space S1. Light source 130 may directly irradiate the fluid in space S1 with ultraviolet light and visible light, or may irradiate the fluid in space S1 with ultraviolet light and visible light through another member, such as a window and/or a mirror. In the present embodiment, storage wall 110 includes window 131 that transmits ultraviolet light and visible light, and light source 130 irradiates space S1 with the ultraviolet light and the visible light through window 131.

The type of light source 130 is not limited as long as the light source can simultaneously emit ultraviolet light and visible light. Examples of light source 130 include light emitting diodes (LEDs), mercury lamps, metal halide lamps, xenon lamps, and laser diodes (LDs). In the present embodiment, light source 130 is a light emitting diode (LED). The wavelength of the ultraviolet light emitted by light source 130 is not limited. From the viewpoint of effective sterilization, the wavelength of the ultraviolet light emitted by light source 130 is preferably 200 nm or more and 350 nm or less, more preferably 200 nm or more and 280 nm or less. That is, the ultraviolet light emitted from light source 130 are preferably ultraviolet C (UVC). The wavelength of the visible light emitted by light source 130 is not limited. The visible light emitted by light source 130 includes light with a wavelength of 360 nm or more and 830 nm or less, and light with a wavelength of 400 nm or more and 480 nm or less. In other words, the light source also emits visible light in the violet to blue range. Examples of commercially available light sources 130 include NCSU334A (Nichia Corporation), which is an ultraviolet light emitting diode with a peak wavelength of 280 nm. Other examples of ultraviolet light emitting diodes with a peak wavelength of 280 nm include KLARAN (Asahi Kasei Corp.) and ZEU110BEAE (Stanley Electric Co., Ltd.).

The position of light source 130 is not limited as long as the fluid in space S1 can be irradiated with ultraviolet light and visible light. Light source 130 may be disposed on first wall 111 or on second wall 112. In the present embodiment, light source 130 is disposed on second wall 112 configured to allow the fluid to flow from supply channel 114 connected to first wall 111 towards discharge channel 115 connected to second wall 112. More specifically, light source 130 is disposed inside second recess 124 provided in second cover 122 in such a way that the optical axis of light source 130 does not cross neither supply port 117 nor discharge port 118.

Window 131 is disposed as part of the wall surface of storage wall 110 (second wall 112), and transmits ultraviolet light and visible light emitted from light source 130 toward the inside of storage wall 110 (space S1). Any material may be used for window 131 as long as the material can transmit ultraviolet light and visible light and has necessary strength. From the viewpoint of improving the sterilization performance, it is preferable that the material of window 131 is a material that transmits ultraviolet light and visible light having wavelengths in the range of 200 nm or more and 830 nm or less. Examples of materials for window 131 include quartz glass, sapphire glass, barium fluoride, and calcium fluoride.

Further, window 131 may have any shape as long as ultraviolet light and visible light emitted from light source 130 can reach space S1. The shape of window 131 may be a flat plate shape or a shape matching the inner surface of storage wall 110. In the present embodiment, window 131 has a flat plate shape and is disposed inside a recess provided in second wall 112. The outer diameter of window 131 is not limited as long as ultraviolet light and visible light emitted from light source 130 can reach space S1. For example, the outer diameter of window 131 is preferably 20 to 50% of the inner diameter of storage wall 110. Increasing the outer diameter of window 131 allows a wide range of space S1 to be directly irradiated with ultraviolet light. On the other hand, reducing the outer diameter of window 131 can increase the ratio of the ultraviolet reflecting surface to the inner surface of space S1.

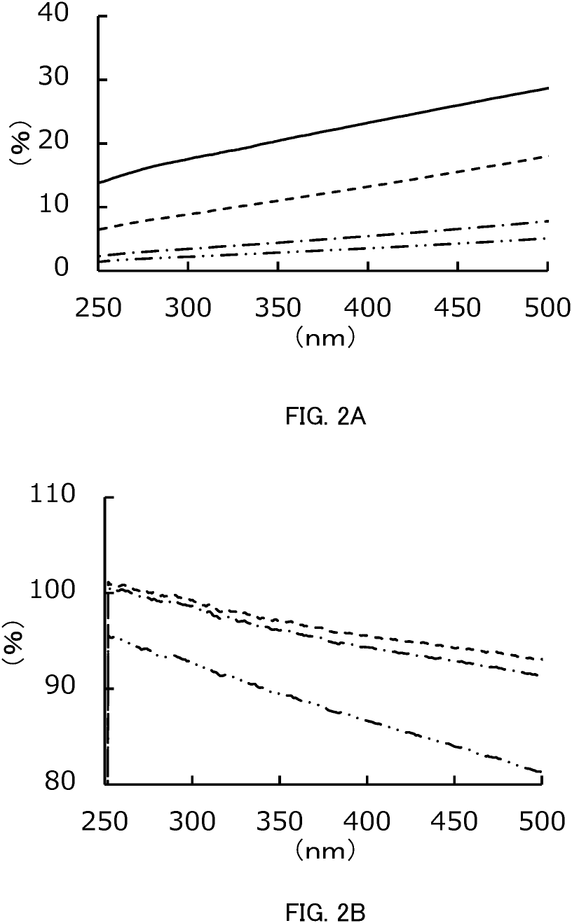

In the following, the relationship between the thickness of first transmission portion 113 and the transmittance and reflectance of light was studied. In the study, PTFE was used as the material for storage wall 110. FIG. 2A is a graph showing the relationship between the wavelength of light and the transmittance of the light in first transmission portions 113 having different thicknesses. FIG. 2B is a graph showing the relationship between the wavelength of light and the reflectance of the light at first transmission portions 113 having different thicknesses. In FIG. 2A, the horizontal axis is the wavelength of light, and the vertical axis is the transmittance of light. In FIG. 2B, the horizontal axis is the wavelength of light, and the vertical axis is the reflectance of light.

In FIG. 2A, the solid line indicates the results when the thickness of first transmission portion 113 is 1 mm, the dashed line indicates the results when the thickness of first transmission portion 113 is 2 mm, the one-dot chain line indicates the results when the thickness of first transmission portion 113 is 5 mm, and the two-dot chain line indicates the results when the thickness of first transmission portion 113 is 7 mm. In FIG. 2B, the dashed line indicates the results when the thickness of first transmission portion 113 is 2 mm, the one-dot chain line indicates the results when the thickness of first transmission portion 113 is 5 mm, and the two-dot chain line indicates the results when the thickness of first transmission portion 113 is 7 mm.

FIG. 2A shows that when the thickness of first transmission portion 113 is reduced, the light transmittance increases, and when the thickness of the first transmission portion 113 is increased, the light transmittance decreases. FIG. 2A also shows that the longer the wavelength of light, the higher the light transmittance.

FIG. 2B shows that when the thickness of first transmission portion 113 is reduced, the light reflectance increases, and when the thickness of the first transmission portion 113 is increased, the light reflectance decreases. FIG. 2B also shows that the longer the wavelength of light, the lower the light reflectance.

As described above, when the thickness of first transmission portion 113 is reduced, the light transmittance increases and the light reflectance increases. Conversely, when the thickness of first transmission portion 113 is increased, the light transmittance decreases and the light reflectance decreases. Reducing the thickness of first transmission portion 113 thus allows transmission of visible light while maintaining reflection of ultraviolet light.

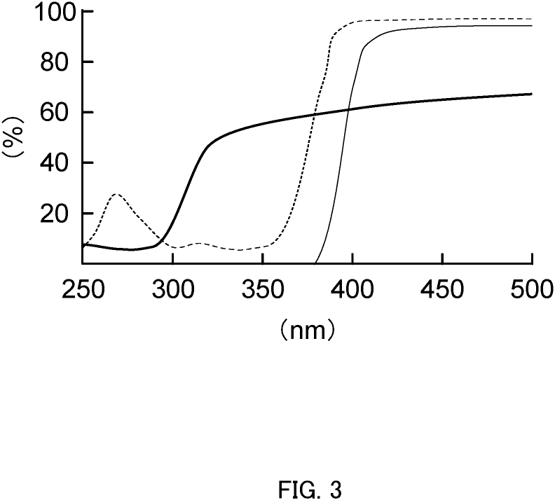

The transmittance of light in second transmission portion 123 was then studied. In this study, the transmittance of light for PP, PC and PMMA was examined. FIG. 3 is a graph showing the relationship between the wavelength of light and the transmittance of the light. In FIG. 3, the horizontal axis is the wavelength of light, and the vertical axis is the transmittance of light. In FIG. 3, the thick solid line indicates the results of PP, the thin solid line indicates the results of PC, and the dashed line indicates the results of PMMA. The thicknesses of PP, PC and PMMA were all set to 2 mm.

FIG. 3 shows that PP, PC and PMMA do not transmit ultraviolet light with a wavelength of approximately 280 nm. FIG. 3 also shows that PC and PMMA transmit visible light with a wavelength of 400 nm to 480 nm in the range of violet to blue. Therefore, the above results show that by coating the front surface or outer surface of translucent PP with PC and PMMA, it is possible to diffuse and/or transmit visible light without transmitting ultraviolet light.

### Method for Using Ultraviolet Irradiation Device

Hereinafter, a method for using an ultraviolet irradiation device according to the present embodiment will be described.

A fluid to be sterilized (for example, water) is introduced into space S1 through supply port 117 and the fluid in space S1 is taken out through discharge port 118 while light source 130 emits ultraviolet light and visible light simultaneously. In this process, the fluid introduced through supply port 117 does not move directly to discharge port 118 but spirals and stays in space S. The fluid may be moved by increasing the pressure on the supply port 117 (supply channel 114) side, or by reducing the pressure on the discharge port 118 (discharge channel 115) side. The intensity of the ultraviolet light and visible light emitted from light source 130 increases as the emission angle with respect to the optical axis (normal to the light emitting surface) of light source 130 decreases, and decreases as the emission angle increases. Therefore, high-intensity ultraviolet light (ultraviolet light with a small emission angle) are directly applied to the fluid and reflected on the inner surface of storage wall 110. At this time, high-intensity ultraviolet light is less likely to reach first transmission portion 113 and thus is less likely to pass through first transmission portion 113 to the outside. On the other hand, part of the visible light with a small emission angle passes through first transmission portion 113 and passes through second transmission portion 123 while being diffused. As described above, in the present embodiment, part of the visible light passes through first transmission portion 113 and second transmission portion 123; thus the operator can visually determine the lighting state of light source 130.

### Effects

As described above, ultraviolet irradiation device 100 according to the present embodiment includes first transmission portion 113, which transmits visible light, and second transmission portion 123, which transmits or diffuses visible light. Therefore, the lighting state of the light source can be visually recognized from the outside of the device.

### Embodiment 2

Hereinafter, ultraviolet irradiation device 200 according to Embodiment 2 will be described. Ultraviolet irradiation device 200 according to the present embodiment differs from ultraviolet irradiation device 100 according to Embodiment 1 only in the presence of sealing member 217. Configurations the same as those of ultraviolet irradiation device 100 according to Embodiment 1 are denoted by the same reference numerals, and descriptions thereof are omitted.

### Configuration of Ultraviolet Irradiation Device

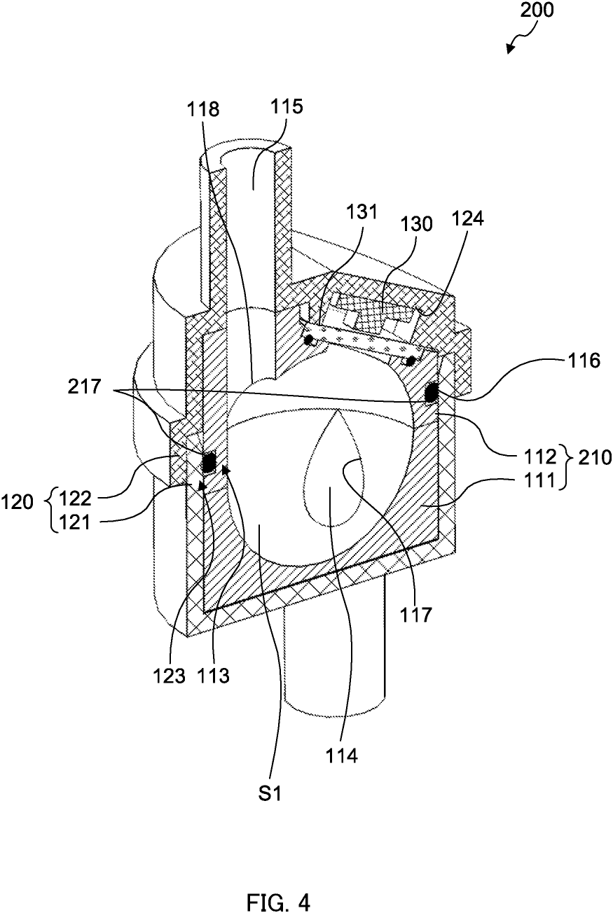

FIG. 4 is a cross-sectional perspective view of ultraviolet irradiation device 200 according to Embodiment 2.

As illustrated in FIG. 4, ultraviolet irradiation device 200 is a device for irradiating fluid with ultraviolet light. Ultraviolet irradiation device 200 includes storage wall 210 defining space S1 configured to store a fluid, cover 120 that covers storage wall 210, and light source 130 configured to emit ultraviolet light and visible light into space S1.

Storage wall 210 includes first transmission portion 113 and defines space S1 configured to house a fluid. Of the light emitted from light source 130, storage wall 210 mainly reflects the ultraviolet light toward space S1 and transmits part of the visible light to the outside through first transmission portion 113. Storage wall 210 includes two members, namely first wall 111 and second wall 112. First transmission portion 113 is disposed in second wall 112, and second wall 112 and first transmission portion 113 are integrally molded. As in the previous embodiment, at least part of first transmission portion 113 is preferably disposed closer to light source 130 than a virtual plane is, in storage wall 210. Here, the virtual plane is a plane passing through the center of gravity of space S1 and perpendicular to the optical axes of the ultraviolet light and the visible light emitted from light source 130. First transmission portion 113 is a region between the inner surface of first recess 116 disposed in the outer surface of storage wall 210 and the inner surface of storage wall 210. As in the previous embodiment, first recesses 116 is a groove in the present embodiment.

Sealing member 217 is disposed inside first recess 116. Sealing member 217 is disposed so as to contact storage wall 210 (second wall 112) and cover 120 (first cover 121), and seals the space between storage wall 210 (second wall 112) and cover 120 (first cover 121). Sealing member 217 may have any shape as long as the sealing member can exhibit the above functions. An example of the shape of sealing member 217 may be a shape complementary to first recess 116 or the shape of an O-ring. In the present embodiment, sealing member 217 is an O-ring. Sealing member 217 is disposed inside first recess 116; thus liquid-tight sealing is possible.

Cover 120 includes second transmission portion 123 and covers storage wall 210. In the present embodiment, cover 120 is formed from two members, namely first cover 121 and second cover 122.

### Effects

As described above, ultraviolet irradiation device 200 according to the present embodiment has the same effects as ultraviolet irradiation device 100 according to Embodiment 1. In addition, ultraviolet irradiation device 200 according to the present embodiment can prevent fluid leakage. Further, the leakage of ultraviolet light to the outside can be prevented, further enhancing the safety.

### Embodiment 3

Hereinafter, ultraviolet irradiation device 300 according to Embodiment 3 will be described. Configurations the same as those of ultraviolet irradiation device 100 according to Embodiment 1 are denoted by the same reference numerals, and descriptions thereof are omitted.

### Configuration of Ultraviolet Irradiation Device

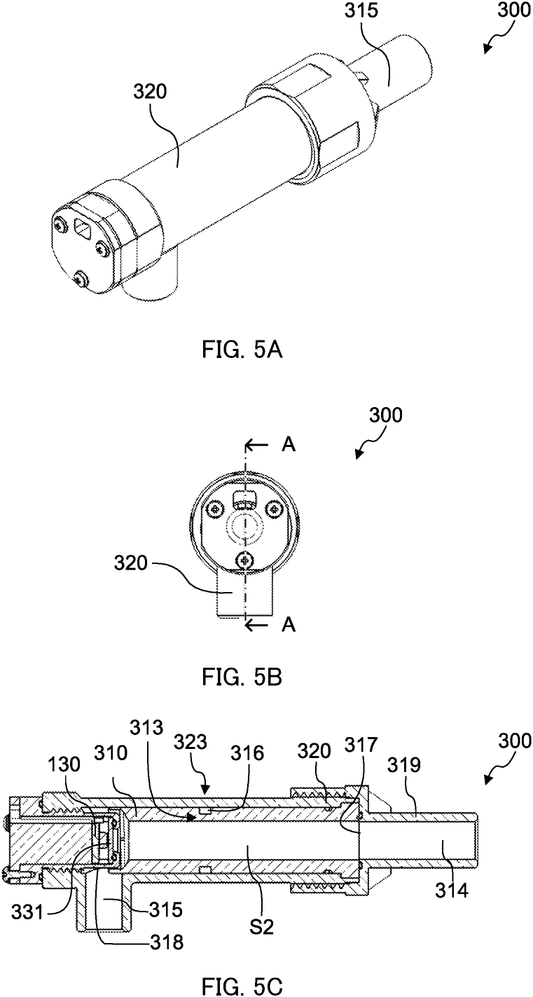

FIG. 5A is a perspective view of ultraviolet irradiation device 300 according to Embodiment 3, FIG. 5B is a front view thereof, and FIG. 5C is a cross-sectional view taken along line A-A of FIG. 5B.

As illustrated in FIGS. 5A to 5C, ultraviolet irradiation device 300 according to the present embodiment is a device for irradiating fluid with ultraviolet light. Ultraviolet irradiation device 300 includes storage wall 310 defining space S2 configured to store a fluid, cover 320 that covers storage wall 310, and light source 130 configured to emit ultraviolet light and visible light into space S2.

Storage wall 310 includes first transmission portion 313 and defines space S2 configured to house a fluid. Of the light emitted from light source 130, storage wall 310 mainly reflects ultraviolet light and transmits visible light. In the present embodiment, storage wall 310 is formed from one member. Space S2 defined by storage wall 310 has a cylindrical shape.

First transmission portion 313 is a region formed thinner than other regions of storage wall 310 and is part of storage wall 310. First transmission portion 313 reflects ultraviolet light emitted from light source 130 and transmits visible light emitted from light source 130. At least part of first transmission portion 313 is preferably disposed closer to light source 130 than a virtual plane is, in storage wall 310. Here, the virtual plane is a plane passing through the center of gravity of space S2 and perpendicular to the optical axes of the ultraviolet light and the visible light emitted from light source 130. In the present embodiment, first transmission portion 313 is disposed so as to circumferentially surround the substantially cylindrical space S2 defined by storage wall 310. Of the ultraviolet light emitted from light source 130, high-intensity ultraviolet light is emitted in the axial direction of space S2, thereby preventing the reduction in the sterilization effect.

In the present embodiment, first transmission portion 313 is a region between the inner surface of first recess 316 disposed in the outer surface of storage wall 110 and the inner surface of storage wall 310. The number of first recesses 316 is not limited. The number of first recesses 316 may be one, or two or more. In the present embodiment, the number of first recesses 316 is one. In the present embodiment, first recess 316 is a groove including two inner surfaces and one bottom surface.

Supply channel 314 supplies a fluid to the inside (space S2) of storage wall 310. In the present embodiment, supply channel 314 is defined by supply pipe 319. One end of supply pipe 319 opens into space S2. The opening of supply channel 314 to space S2 is supply port 317. Supply pipe 319 is connected to cover 320 by screwing the pipe to the cover.

Discharge channel 315 discharges the fluid inside storage wall 310 (space S2). In the present embodiment, discharge channel 315 is defined by cover 320. One end of discharge channel 315 opens into space S2. The opening of discharge channel 315 to space S2 is discharge port 318.

Cover 320 includes second transmission portion 323 and covers storage wall 310. Cover 320 transmits or diffuses visible light that has passed through first transmission portion 313. In the present embodiment, cover 320 is formed from one member.

Second transmission portion 323 transmits or diffuses visible light that has passed through first transmission portion 313. In the present embodiment, second transmission portion 323 is a part of cover 320, the part facing first transmission portion 313.

Light source 130 irradiates a fluid inside storage wall 310 (space S2) with ultraviolet light and visible light simultaneously. Light source 130 may directly irradiate the fluid in space S2 with ultraviolet light and visible light, or may irradiate the fluid in space S2 with ultraviolet light and visible light through another member, such as a window and/or a mirror. In the present embodiment, storage wall 310 includes window 331 that transmits ultraviolet light and visible light, and light source 130 irradiates space S1 with the ultraviolet light and the visible light through window 131.

The position of light source 130 is not limited as long as the fluid in space S2 can be irradiated with ultraviolet light and visible light. In the present embodiment, light source 130 is disposed at one end of storage wall 310.

Window 331 is disposed as part of the wall surface of storage wall 310, and transmits ultraviolet light and visible light emitted from light source 130 toward the inside of storage wall 310 (space S2).

### Effects

As described above, ultraviolet irradiation device 300 according to the present embodiment has the same effects as ultraviolet irradiation device 100 according to Embodiment 1.

### INDUSTRIAL APPLICABILITY

The ultraviolet irradiation devices according to the above embodiments are particularly advantageous for sterilizing, for example, clean water, agricultural water, food washing water, various types of washing water, bath water, pool water, and the like.

### REFERENCE SIGNS LIST

100, 200, 300 Ultraviolet irradiation device
110, 210, 310 Storage wall
111 First wall
112 Second wall
113, 313 First transmission portion
114, 314 Supply channel
115, 315 Discharge channel
116, 316 First recess
117, 317 Supply port
118, 318 Discharge port
120, 320 Cover
121 First cover
122 Second cover
123, 323 Second transmission portion
124 Second recess
130 Light source
131, 331 Window
217 Sealing member
319 Supply pipe

1. An ultraviolet irradiation device configured to irradiate a fluid with ultraviolet light, the ultraviolet irradiation device comprising:
a storage wall defining a space configured to store the fluid; and
a light source configured to simultaneously emit the ultraviolet light and visible light into the space, wherein
the storage wall includes a first transmission portion formed thinner than a region of the storage wall other than the first transmission portion, the first transmission portion being configured to transmit part of the visible light emitted from the light source to the space.

2. The ultraviolet irradiation device according to claim 1, wherein, in the storage wall, at least part of the first transmission portion is disposed closer to the light source than a virtual plane is, the virtual plane being a plane passing through a center of gravity of the space and perpendicular to optical axes of the ultraviolet light and the visible light emitted from the light source.

3. The ultraviolet irradiation device according to claim 1, wherein the first transmission portion is a region between an inner surface of the storage wall and a recess disposed in an outer surface of the storage wall.

4. The ultraviolet irradiation device according to claim 2, wherein the first transmission portion is a region between an inner surface of the storage wall and a recess disposed in an outer surface of the storage wall.

5. The ultraviolet irradiation device according to claim 1, further comprising:
a cover that covers the storage wall, wherein
the cover includes a second transmission portion configured to transmit or diffuse the part of the visible light transmitted by the first transmission portion.

6. The ultraviolet irradiation device according to claim 2, further comprising:
a cover that covers the storage wall, wherein
the cover includes a second transmission portion configured to transmit or diffuse the part of the visible light transmitted by the first transmission portion.

7. The ultraviolet irradiation device according to claim 3, further comprising:
a cover that covers the storage wall, wherein
the cover includes a second transmission portion configured to transmit or diffuse the part of the visible light transmitted by the first transmission portion.

8. The ultraviolet irradiation device according to claim 4, further comprising:
a cover that covers the storage wall, wherein
the cover includes a second transmission portion configured to transmit or diffuse the part of the visible light transmitted by the first transmission portion.

9. The ultraviolet irradiation device according to claim 5, wherein the cover including the second transmission portion is made of one type of material.

10. The ultraviolet irradiation device according to claim 3, wherein a sealing member is disposed inside the recess so as to contact the storage wall and the cover.
